(19) United States
(12) Patent Application Publication
(10) Pub. No.: US 2025/0224806 A1
(43) Pub. Date: Jul. 10, 2025

(54) GESTURE SENSING DEVICE, GESTURE SENSING SYSTEM AND SENSING METHOD

(71) Applicant: Samsung Display Co., LTD., Yongin-si (KR)

(72) Inventors: Satoshi UCHINO, Yokohama (JP); Masahiko TAKIGUCHI, Yokohama (JP); Kazuhiro MATSUMOTO, Yokohama (JP)

(21) Appl. No.: 18/905,731

(22) Filed: Oct. 3, 2024

(30) Foreign Application Priority Data
Jan. 5, 2024 (KR) 10-2024-0002041

(51) Int. Cl. G06F 3/01; G01S 7/35; G01S 13/58; G01S 13/62

(52) U.S. Cl. CPC G06F 3/017; G01S 7/356; G01S 13/584; G01S 13/62

(57) ABSTRACT

A gesture sensing device includes a preprocessor that generates a range-Doppler map including information about a distance, a relative velocity, and an angle to an object based on a reception data signal, and outputs sensing data, an analyzer that analyzes a gesture feature of the object based on the range-Doppler map, and a visualizer that visualizes a gesture of the object that was analyzed by the analyzer.

This application claims priority to Korean Patent Application No. 10-2024-0002041, filed on Jan. 5, 2024, and all the benefits accruing therefrom under 35 U.S.C. § 119, the content of which in its entirety is herein incorporated by reference.

### BACKGROUND

### 1. Field of Disclosure

The invention relates to a gesture sensing device, and more particularly to a gesture sensing device, a gesture sensing system and a sensing method.

### 2. Description of Related Art

A mmWave is a high-bandwidth frequency between 30 and 300 GHz. The mm Wave frequency has strong linearity, and thus is not affected by weather such as rain or fog. Accordingly, mmWave frequency technology is being applied to autonomous driving technologies such as collision avoidance in vehicles.

Moreover, because an antenna for transmitting and receiving mm Wave frequencies is capable of being miniaturized, the antenna may also be used for a sensor which is applied to a method of monitoring and surveilling of traffic.

### SUMMARY

Embodiments of the invention provide a gesture sensing device for detecting a gesture from sensing data which is sensed by a mmWave antenna.

Embodiments of the invention provide a gesture sensing system including a sensor for detecting the mmWave signal, and a sensing method thereof.

According to an embodiment, a gesture sensing device includes a preprocessor that generates a range-Doppler map including information about a distance, a relative velocity, and an angle to an object based on a received data signal, and to output sensing data, an analyzer that analyzes a gesture feature of the object based on the range-Doppler map, and a visualizer that visualizes a gesture of the object analyzed by the analyzer.

In an embodiment, the analyzer may analyze the gesture feature of the object by detecting a temporal change in the gesture of the object using the range-Doppler map.

In an embodiment, the analyzer may detect a peak location of the sensing data by using the range-Doppler map, preserve a peak trace of the peak location, resample a peak of the sensing data, and compare vector similarity between the peak trace of the peak location and the resampled result.

In an embodiment, the analyzer may create an ideal curve of a peak trace of the gesture based on the peak trace and the resampled result.

In an embodiment, the visualizer may visualize the gesture of the object by using similarities between the gesture and an artificial ideal curve, and a time change in angle information.

In an embodiment, the analyzer may resample the peak trace by applying an equation which approximates the peak trace to a change in an observed distance, velocity, and signal intensity.

In an embodiment, the preprocessor may generate the range-Doppler map by performing Fast Fourier Transform (FFT) on the reception data signal.

In an embodiment, the reception data signal may be a signal which is received through the mmWave antenna.

According to an embodiment, a gesture sensing system includes a transmitter that transmits a mmWave transmission signal to a transmission antenna, a mixer that outputs an intermediate frequency signal by combining the reception signal, which is received from a reception antenna, and the mmWave transmission signal, a receiver that outputs a reception data signal by performing filtering and analog-to-digital conversion on the intermediate frequency signal, a preprocessor that generates a range-Doppler map including information about a distance, a relative velocity, and an angle to an object based on the reception data signal, and outputs sensing data, an analyzer that analyzes a gesture feature of the object based on the range-Doppler map, and a visualizer that visualizes a gesture of the object analyzed by the analyzer.

In an embodiment, the analyzer may analyze the gesture feature of the object by detecting a temporal change in the gesture of the object by using the range-Doppler map.

In an embodiment, the analyzer may detect a peak location of the sensing data by using the range-Doppler map, preserve a peak trace of the peak location, resample a peak of the sensing data, and compare vector similarity between the peak trace of the peak location and the resampled result.

In an embodiment, the analyzer may create an ideal curve of a peak trace of the gesture based on the peak trace and the resampled result.

In an embodiment, the visualizer may visualize the gesture of the object by using similarities between the gesture and an artificial ideal curve, and a time change in angle information.

In an embodiment, the analyzer may resample the peak trace by applying an equation which approximates the peak trace to a change in an observed distance, velocity, and signal intensity.

In an embodiment, the preprocessor may generate the range-Doppler map by performing FFT on the reception data signal.

According to an embodiment, a method for sensing a gesture includes generating a range-Doppler map including information about a distance, a relative velocity, and an angle to an object which is based on a reception data signal, detecting a peak location of sensing data by using the range-Doppler map, preserving a peak trace of the peak location, resampling a peak of the sensing data, and comparing vector similarities between the peak trace of the peak location and the resampled result.

In an embodiment, the gesture sensing method may further include creating an ideal curve of a peak trace of the gesture based on the peak trace and the resampled result.

In an embodiment, the gesture sensing method may further include visualizing the gesture of the object by using similarities between the gesture and an artificial ideal curve, and a time change in angle information.

In an embodiment, the resampling of the peak of the sensing data may include resampling the peak trace by applying an equation which approximates the peak trace to a change in an observed distance, velocity, and signal intensity.

In an embodiment, the generating of the range-Doppler map may include generating the range-Doppler map by performing FFT on the reception data signal.

### BRIEF DESCRIPTION OF THE FIGURES

The above and other objects and features of the invention will become apparent by describing in detail embodiments thereof with reference to the accompanying drawings.

FIG. 1 is a schematic block diagram of a gesture sensing system, according to an embodiment.

FIG. 2 is a schematic block diagram of a gesture sensing device, according to an embodiment.

FIG. 3 is a block diagram illustrating an operation of a preprocessor in the gesture sensing device shown in FIG. 2, according to an embodiment.

FIG. 4 is a graphical diagram illustrating a range and a Doppler of a range-FFT converter, according to an embodiment.

FIG. 5 is a graphical diagram showing a range-Doppler map, according to an embodiment.

FIG. 6 is a graphical diagram showing a range-angle map, according to an embodiment.

FIG. 7 is a flowchart showing a method of calculating a range-angle map in a preprocessor, according to an embodiment.

FIG. 8 is a series of diagrams for describing a method for calculating an angle index, according to an embodiment.

FIG. 9 is a flowchart showing an operation of an analyzer, according to an embodiment.

FIG. 10A is a diagram showing a peak trace according to a gesture of an object, according to an embodiment.

FIG. 10B is a diagram showing a peak trace according to a gesture of an object, according to an embodiment.

FIG. 11A is a plot diagram showing the result of resampling a peak trace by applying an approximation equation to a change in distance in sensing data, according to an embodiment.

FIG. 11B is a plot diagram showing the result of resampling a peak trace by applying an approximation equation to a change in velocity in sensing data, according to an embodiment.

FIG. 11C is a plot diagram showing the result of resampling a peak trace by applying an approximation equation to a change in signal intensity in sensing data, according to an embodiment.

FIG. 12A is a plot diagram showing that median values according to a time change of peak traces corresponding to a push gesture is sampled, according to an embodiment.

FIG. 12B is a plot diagram showing that median values according to a time change of peak traces corresponding to a pull gesture is sampled, according to an embodiment.

FIG. 12C is a plot diagram showing that median values according to a time change of peak traces corresponding to a snap gesture is sampled, according to an embodiment.

FIG. 12D is a plot diagram showing that median values according to a time change of peak traces corresponding to a grab push gesture is sampled, according to an embodiment.

FIG. 12E is a plot diagram showing that median values according to a time change of peak traces corresponding to a grab gesture is sampled, according to an embodiment.

FIG. 12F is a plot diagram showing that median values according to a time change of peak traces corresponding to a swipe gesture is sampled, according to an embodiment.

FIG. 13A is a plot diagram showing ideal curves of a peak trace corresponding to a push gesture, according to an embodiment.

FIG. 13B is a plot diagram showing ideal curves of a peak trace corresponding to a pull gesture, according to an embodiment.

FIG. 13C is a plot diagram showing ideal curves of a peak trace corresponding to a snap gesture, according to an embodiment.

FIG. 13D is a plot diagram showing ideal curves of a peak trace corresponding to a grab push gesture, according to an embodiment.

FIG. 13E is a plot diagram showing ideal curves of a peak trace corresponding to a grab gesture, according to an embodiment.

FIG. 13F is a plot diagram showing ideal curves of a peak trace corresponding to a swipe gesture, according to an embodiment.

FIG. 14 is a plot diagram showing an ideal curve, according to an embodiment.

FIG. 15A is a plot diagram comparing an ideal curve calculated from a trace of a peak curve for a specific gesture with ideal curves of other gestures, according to an embodiment.

FIG. 15B is a plot diagram comparing an ideal curve calculated from a trace of a peak curve for a specific gesture with ideal curves of other gestures, according to an embodiment.

FIG. 15C is a plot diagram comparing an ideal curve calculated from a trace of a peak curve for a specific gesture with ideal curves of other gestures, according to an embodiment.

FIG. 15D is a plot diagram comparing an ideal curve calculated from a trace of a peak curve for a specific gesture with ideal curves of other gestures, according to an embodiment.

FIG. 15E is a plot diagram comparing an ideal curve calculated from a trace of a peak curve for a specific gesture with ideal curves of other gestures, according to an embodiment.

FIG. 15F is a plot diagram comparing an ideal curve calculated from a trace of a peak curve for a specific gesture with ideal curves of other gestures, according to an embodiment.

FIG. 16 is a diagram indicated by visualizing a feature distribution according to a similarity between each gesture and an artificial ideal curve, and a time change of angle information, according to an embodiment.

FIG. 17 is a diagram showing the distribution of data used for inference in training results of an AI processor, according to an embodiment.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

Like reference numerals refer to like components. Also, in drawings, the thickness, ratio, and dimension of components are exaggerated for effectiveness of description of technical contents. The term “and/or” includes one or more combinations of the associated listed items.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the invention belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the invention will be described with reference to accompanying drawings.

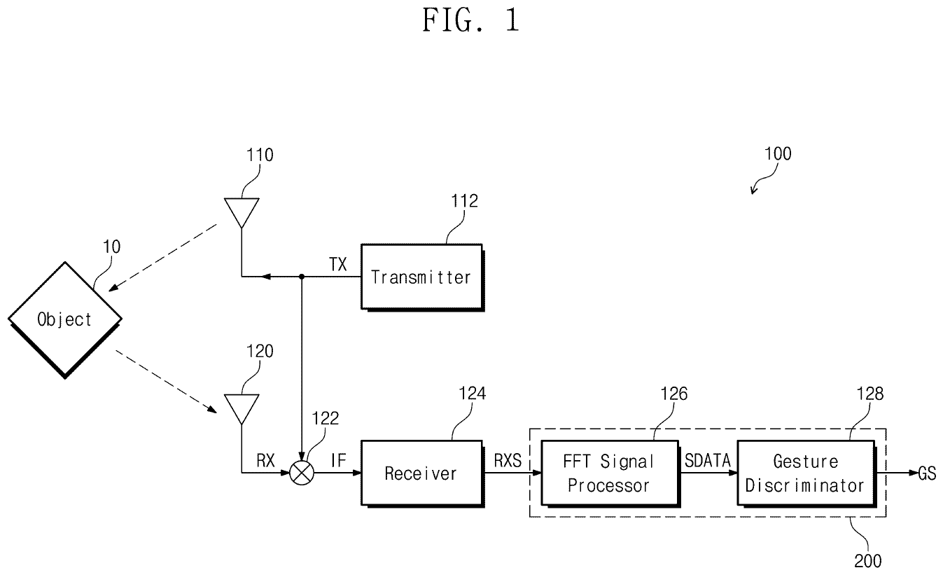

FIG. 1 is a block diagram of a gesture sensing system 100, according to an embodiment.

In an embodiment and referring to FIG. 1, the gesture sensing system 100 includes a transmission antenna 110, a transmitter 112, a reception antenna 120, a mixer 122, a receiver 124, a fast Fourier transform (FFT) signal processor 126, and a gesture discriminator 128.

The transmitter 112 outputs a mmWave transmission signal TX to the transmission antenna 110. The mmWave transmission signal TX output from the transmission antenna 110 may be reflected by an object 10 and then may be delivered to the reception antenna 120. The mixer 122 receives the reception signal RX from the reception antenna 120 and the mmWave transmission signal TX from the transmitter 112 and outputs an intermediate frequency signal IF by combining the mmWave transmission signal TX from the transmitter 112 and the reception signal RX received from the reception antenna 120.

The receiver 124 receives the intermediate frequence signal IF from the mixer 122 and outputs a reception data signal RXS by performing filtering and analog-to-digital conversion on the intermediate frequency signal IF from the mixer 122. For example, the intermediate frequency signal IF may be an analog signal, and the reception data signal RXS may be a digital signal.

The FFT signal processor 126 receives the reception data signal RXS and outputs sensing data SDATA based on the reception data signal RXS. The sensing data SDATA may include information about the distance and angle between the gesture sensing system 100 and the object 10, and the relative speed of the object 10.

The gesture discriminator 128 receives the sensing data SDATA from the FFT Signal Processor 126 and determines the gesture of the object 10 based on the sensing data SDATA and outputs a gesture signal GS.

In an embodiment, the FFT signal processor 126 and the gesture discriminator 128 may be referred to as a “gesture sensing device 200”.

In an embodiment, the gesture sensing system 100 may detect an object 10 by using a phase difference between the transmission signal TX and the reception signal RX, which is caused by a physical distance between the gesture sensing system 100 and the object 10.

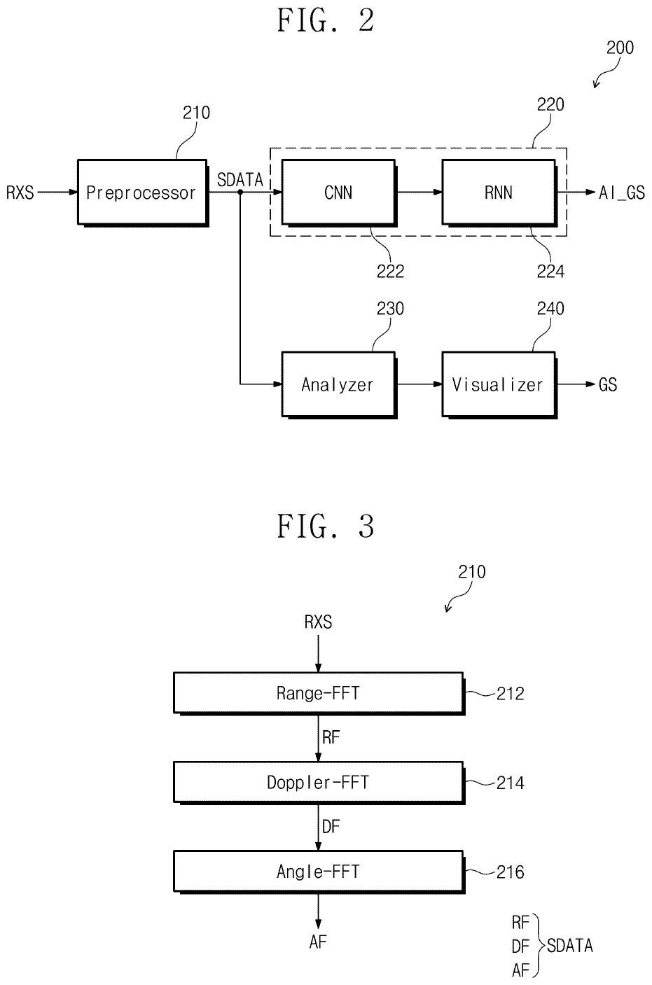

FIG. 2 is a block diagram of the gesture sensing device 200, according to an embodiment.

In an embodiment and referring to FIG. 2, the gesture sensing device 200 includes a preprocessor 210, an artificial intelligence (AI) processor 220, an analyzer 230, and a visualizer 240.

In an embodiment, the preprocessor 210 may be the same as the FFT signal processor 126 shown in FIG. 1. Also, in an embodiment, the analyzer 230 and the visualizer 240 may correspond to the gesture discriminator 128 shown in FIG. 1.

The preprocessor 210 receives the reception data signal RXS from the receiver 124 shown in FIG. 1 and outputs the sensing data SDATA.

In an embodiment, the AI processor 220 may include convolutional neural networks (CNN) 222 and recurrent neural networks (RNN) 224, where the AI processor 220 determines the gesture of the object 10 (see FIG. 1) based on the sensing data SDATA by using the CNN 222 and the RNN 224 and then outputs an AI gesture signal AI_GS.

The analyzer 230 receives the sensing data SDATA and analyzes the gesture feature of the object 10 (see FIG. 1) based on the sensing data SDATA.

The visualizer 240 receives an analyzed gesture signal from the analyzer 230 and outputs the gesture signal GS obtained by visualizing features of the gesture analyzed signal received from the analyzer 230.

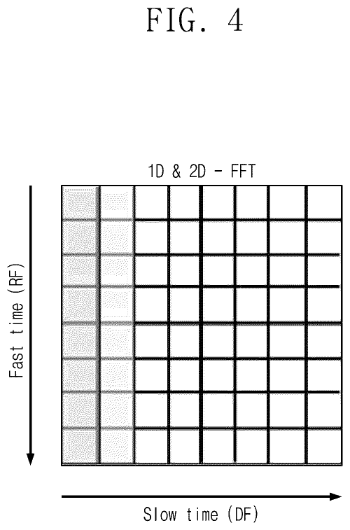

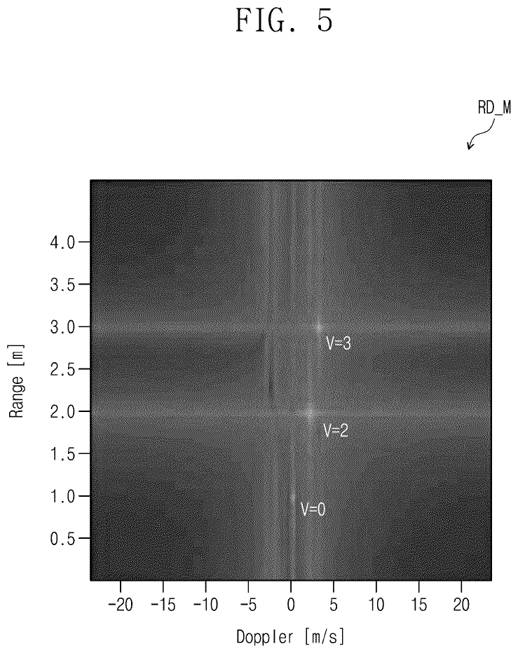

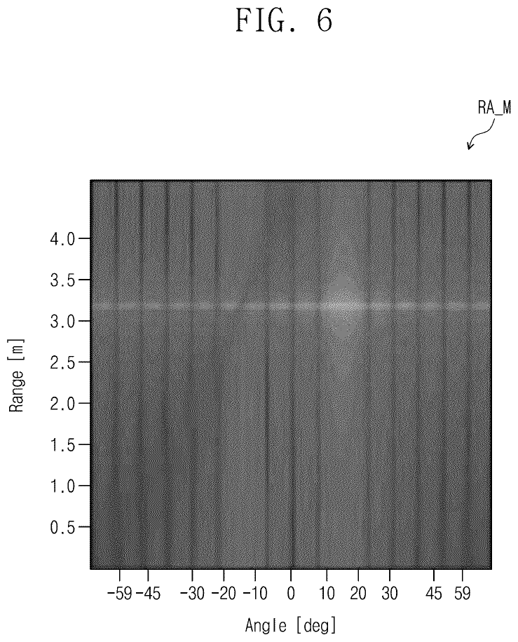

FIG. 3 is a block diagram of the preprocessor 210 shown in FIG. 2, according to an embodiment. FIG. 4 is a diagram illustrating a range RF and a Doppler DF of a range-FFT converter 212, according to an embodiment. FIG. 5 is a diagram showing a range-Doppler map RD_M, according to an embodiment. FIG. 6 is a diagram showing a range-angle map RA_M, according to an embodiment.

In an embodiment and referring to FIGS. 3, 4, 5, and 6, the preprocessor 210 includes a range-FFT converter 212, a Doppler-FFT converter 214, and an angle-FFT converter 216.

The range-FFT converter 212 receives the reception data signal RXS from the receiver 124 and performs FFT by sampling the reception data signal RXS from the receiver 124 shown in FIG. 1 to generate a range RF output. The range-FFT converter 212 may perform FFT to obtain range information for “fast time”. The range-FFT converter 212 may output the range RF, where the range RF output from the range-FFT converter 212 may be a distance between the gesture sensing system 100 and the object 10 (see FIG. 1).

In an embodiment, the range-FFT converter 212 may be a one-dimensional (1-D) FFT.

In an embodiment, the Doppler-FFT converter 214 may receive the range RF output from the range-FFT converter 212 and perform Doppler-FFT on the range RF output to generate and output the Doppler DF output. The Doppler-FFT converter 214 may perform Doppler-FFT only once per frame and thus may be called “slow time”. The Doppler DF output from the Doppler-FFT converter 214 may be the relative velocity with respect to the object 10 (see FIG. 1).

In an embodiment, the Doppler-FFT converter 214 may be a two-dimensional (2-D) FFT.

In an embodiment, the range-Doppler map RD_M shown in FIG. 5 may be generated by the range-FFT converter 212 and the Doppler-FFT converter 214. FIG. 5 shows a range when Doppler (V) is about 0 m/s, about 2 m/s, and about 3 m/s.

In an embodiment, the angle-FFT converter 216 generates an angle AF output by performing FFT on the Doppler DF output from the Doppler-FFT converter 214. After the FFT of the angle-FFT converter 216 is performed, the range-angle map RA_M shown in FIG. 6 may be generated.

In an embodiment, the sensing data SDATA may include the range RF, the Doppler DF, and the angle AF.

In an embodiment, the AI processor 220 shown in FIG. 2 may determine the gesture of the object 10 (see FIG. 1) based on the range-Doppler map RD_M and may output the AI gesture signal AI_GS.

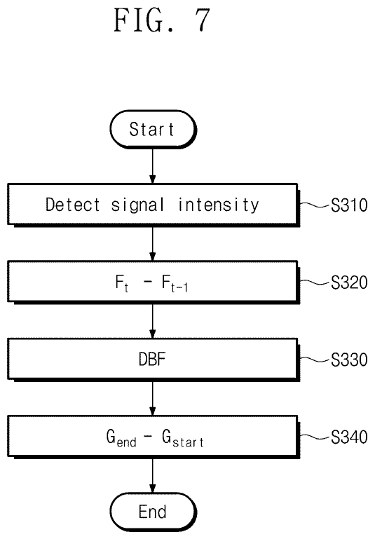

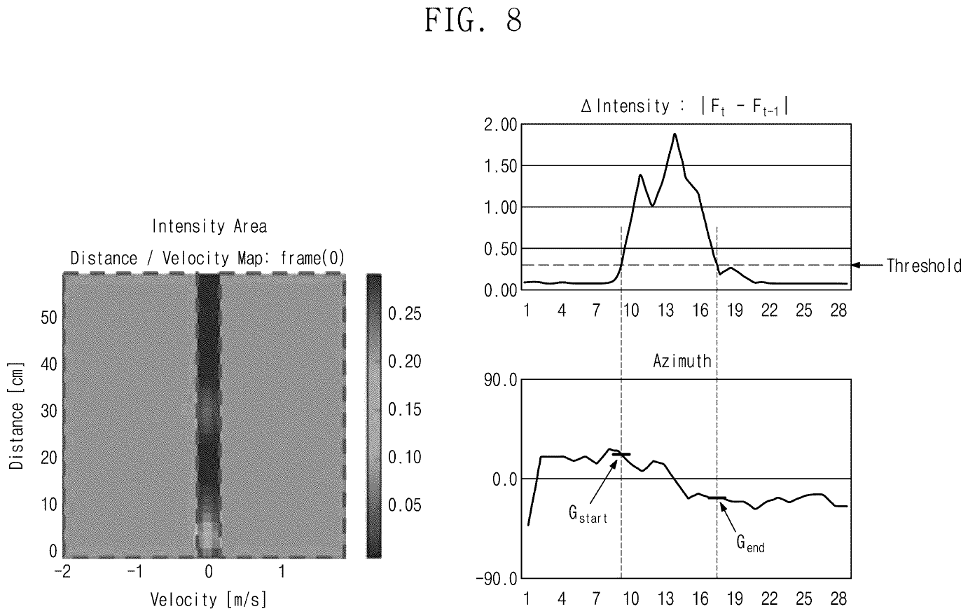

FIG. 7 is a flowchart showing a method of calculating a range-angle map RA_M in the preprocessor 210, according to an embodiment. FIG. 8 is a plurality of diagrams for describing a method for calculating an angle index, according to an embodiment.

In an embodiment and referring to FIGS. 2, 7, and 8, the preprocessor 210 detects the intensity of the reception data signal RXS (operation S310).

The preprocessor 210 calculates a difference between intensity Fr of the signal RXS at time (t) and intensity Fₜ₋₁ of the signal RXS at time (t−1) (operation S320).

The preprocessor 210 performs digital beam Forming (DBF) (operation S330).

The preprocessor 210 determines a starting point G_{end} and an ending point Gₛₜₐᵣₜ of a gesture and then calculates a time change (an index value) of an angle from a difference in azimuth information calculated from the DBF based on the starting point G_{end} and the ending point Gₛₜₐᵣₜ (operation S340). The preprocessor 210 may calculate an angle index based on the time change of the angle.

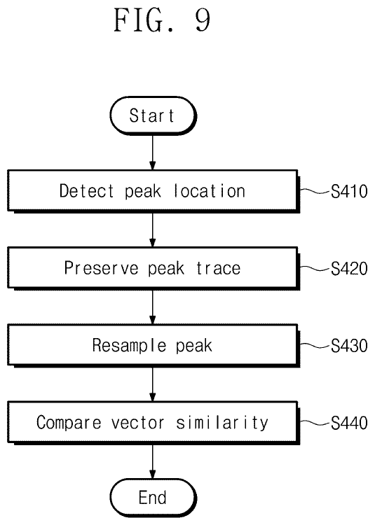

FIG. 9 is a flowchart showing an operation of the analyzer 230, according to an embodiment.

Referring to FIGS. 2 and 9, in an embodiment, the analyzer 230 may be implemented as a processor which performs an algorithm.

In an embodiment, the analyzer 230 detects a peak location of the sensing data SDATA based on the range-Doppler map RD_M (see FIG. 5) (operation S410). In another embodiment, the analyzer 230 may detect a change in a temporal peak location of each of the frames by using an infinite impulse response (IIR) filter.

The analyzer 230 preserves the trace of the peak location of the sensing data SDATA (operation S420). The analyzer 230 may preserve the trace (i.e., a peak trace) of the peak location for a specific period of time by using the peak of the sensing data SDATA (i.e., a distance, a velocity, signal intensity, or the like) as a vector.

The preservation of the peak trace of the peak location is based on a point in time when the operation of the object 10 is started. The analyzer 230 may compare changes in velocity and signal intensity of the movement of the object 10 with a specific reference value from existing observation results and then may determine the start of the preservation of the peak trace of the peak location based on the comparison results.

FIGS. 10A and 10B are diagrams showing a peak trace of the peak location according to a gesture of the object 10, according to an embodiment.

FIGS. 10A and 10B show a trace of a peak location of the sensing data SDATA for a push gesture in which the object 10 is a user's hand which approaches the gesture sensing system 100 (see FIG. 1) with the user's hand open.

As shown in FIGS. 10A and 10B, even though the same push gesture occurs, a temporal change in a peak trace of the sensing data SDATA may be different at each time depending on minute differences in distance and velocity. This means that there is a deviation in the peak trace even though the same gesture occurs.

In an embodiment and referring again to FIGS. 2 and 9, the analyzer 230 resamples the peak of the sensing data SDATA (operation S430). In a method of preserving a peak trace, a starting point and an ending point (i.e., time required to draw a specific peak trace) are different for each gesture. Accordingly, the total number of preserved vectors may not be constant. Moreover, a location that deviates greatly from a trace estimated depending on slight deviations of the peak trace according to the measurement and situations may be observed as a peak. To correct for this and to constantly keep the number of times that vectors to be described later are compared, the analyzer 230 resamples a peak trace by applying an equation which approximates the peak trace to the changes in observed distance, velocity, and signal intensity.

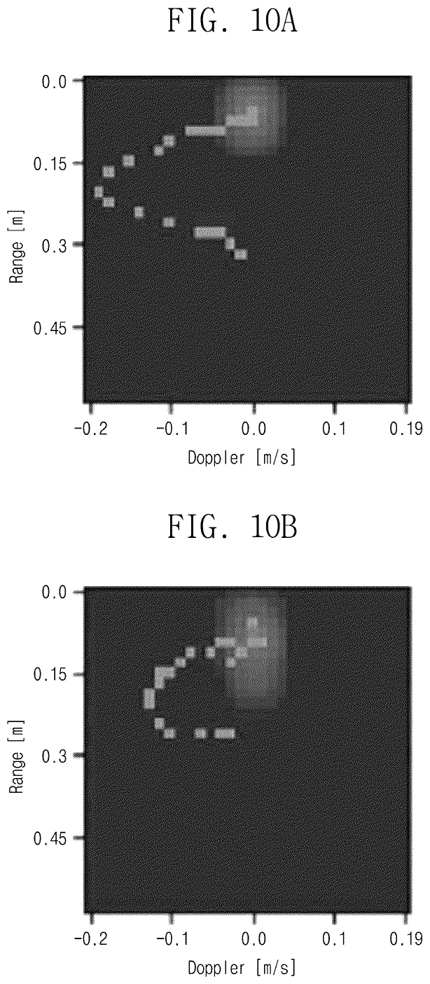

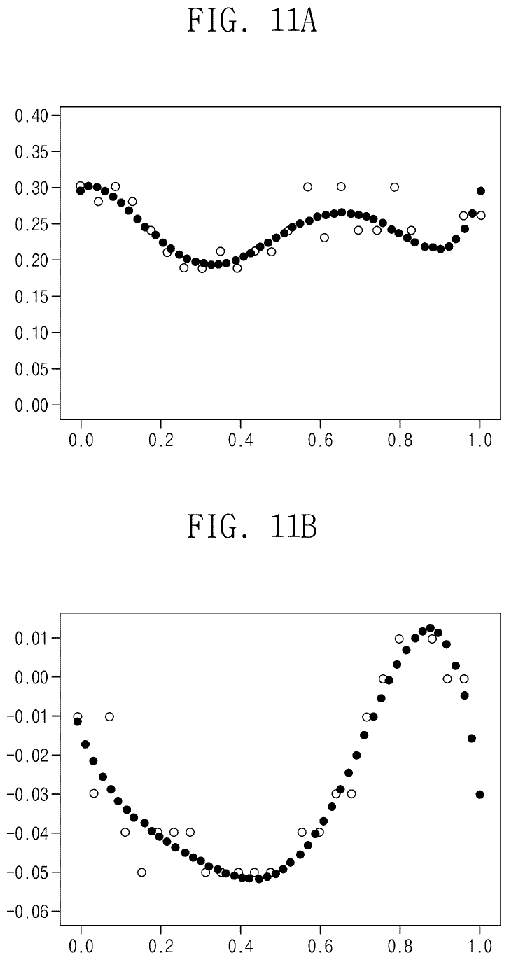

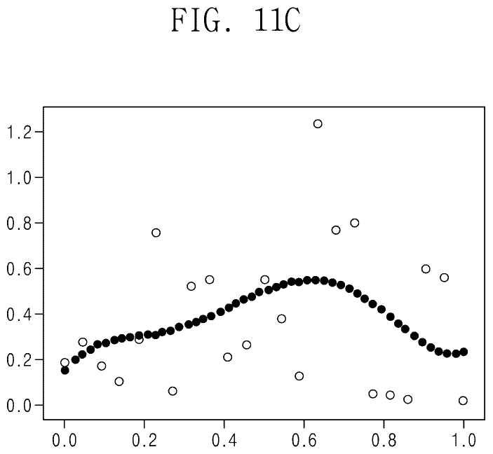

FIG. 11A shows the result of resampling a peak trace by applying an approximation equation to a change in distance in the sensing data SDATA, according to an embodiment.

FIG. 11B shows the result of resampling a peak trace by applying an approximation equation to a change in velocity in the sensing data SDATA, according to an embodiment.

FIG. 11C shows the result of resampling a peak trace by applying an approximation equation to a change in signal intensity in the sensing data SDATA, according to an embodiment.

In an embodiment and referring to FIGS. 2, 9, 11A, 11B, and 11C, the analyzer 230 calculates a vector set based on a peak trace and resampled results and creates an ideal curve (statistical representative points) of the peak trace for each gesture.

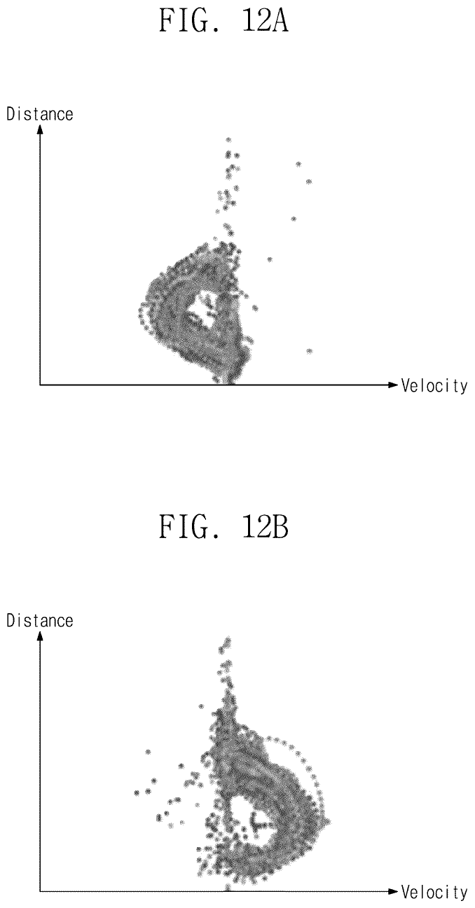

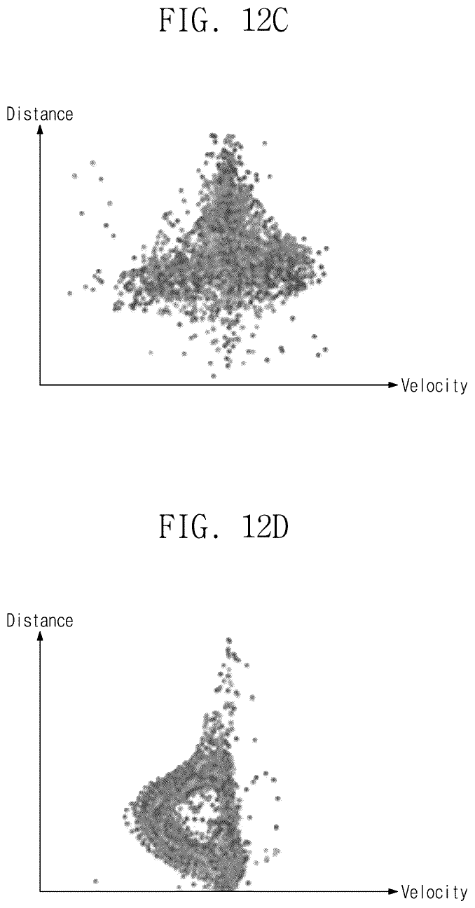

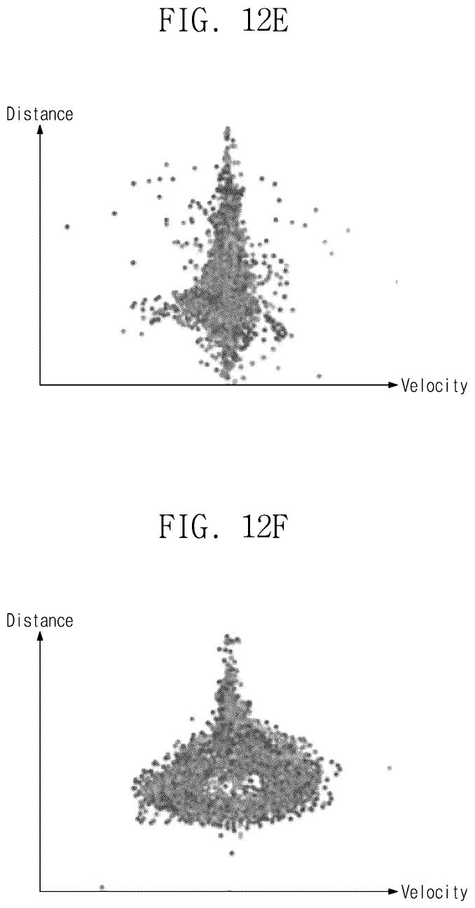

FIGS. 12A, 12B, 12C, 12D, 12E, and 12F shows that median values according to a time change of peak traces corresponding to push, pull, snap, grab push, grab, and swipe gestures are sampled, respectively, according to an embodiment.

The number of samples in each of FIGS. 12A to 12F is 80.

Descriptions of gestures are shown in Table 1 below.

TABLE 1

| Gestures | Descriptions |
|---|---|
| Push | Approach sensor with hands open |
| Pull | Get out of sensor with hands open |
| Snap | Place hand over sensor and move wrist left and right |
| Grab push | close hand and push it |
| Grab | Open hand and close it right away |
| Swipe | Move hand left and right over sensor |

In Table 1, a ‘sensor’ may be the gesture sensing system 100 shown in FIG. 1, according to an embodiment.

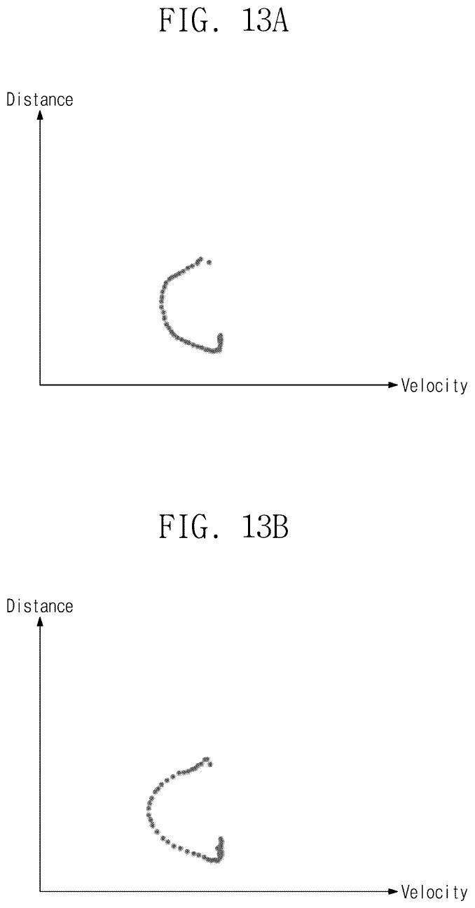

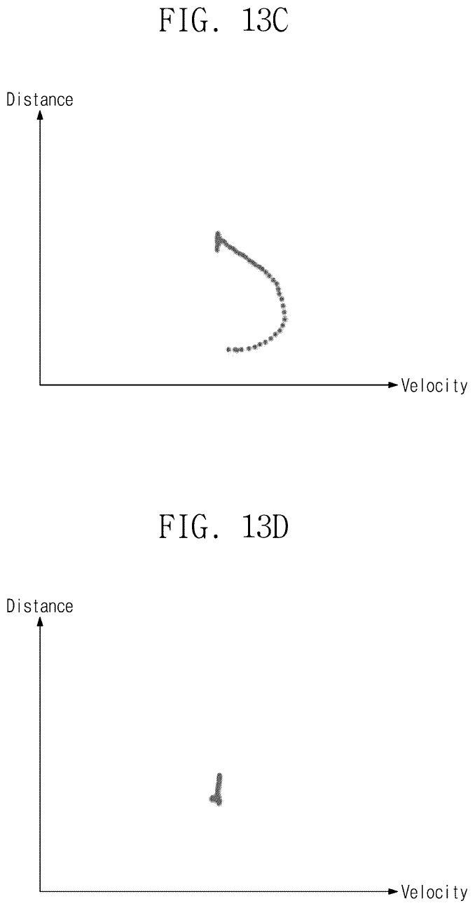

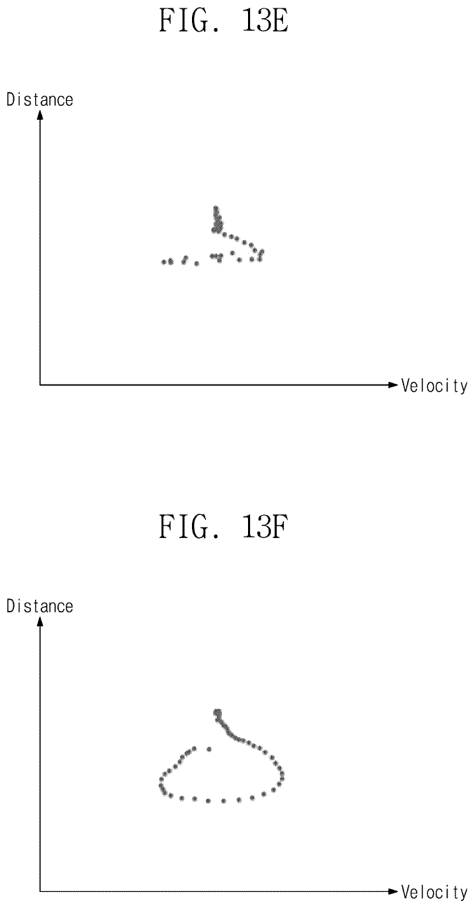

FIGS. 13A, 13B, 13C, 13D, 13E, and 13F show ideal curves of a peak trace corresponding to push, pull, snap, grab push, grab, and swipe gestures, respectively, according to an embodiment.

In an embodiment and referring to FIGS. 2, 9, 12A to 12F, and 13A to 13F, the analyzer 230 defines an ideal curve (i.e., an artificial representative point) that does not match an ideal curve on the range-Doppler map RD_M (see FIG. 5) to relatively compare the feature distribution of a gesture.

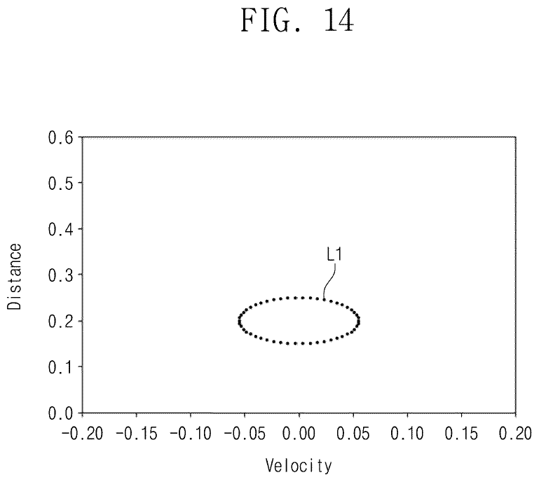

FIG. 14 is a diagram showing an ideal curve L1.

In FIG. 14, the ideal curve L1 of an ellipse that does not overlap an ideal curve of each gesture is shown as an example. It is assumed that representative points of the ideal curve L1 are different from those of the ideal curve of each gesture. Accordingly, the ideal curve L1 is not limited to that shown in FIG. 14.

In an embodiment and referring to FIGS. 2 and 9, the analyzer 230 compares the vector similarity between the peak trace and the resampled result (operation S440).

In an embodiment, the vector similarity Similarity(A, B) may be calculated by using a cosine similarity formula as shown in Equation 1 below.

$$Similarity ( A , B ) = cos ( θ ) = \frac{A \cdot B}{‖ A ‖ ‖ B ‖} , \qquad ( Equation 1 )$$

where in Equation 1, ‘A’ may be a peak trace, and ‘B’ may be a resampled result.

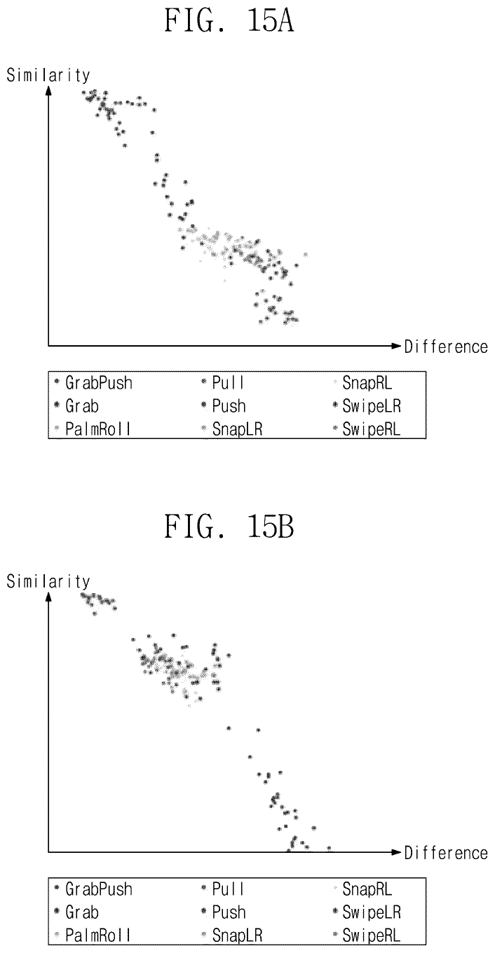

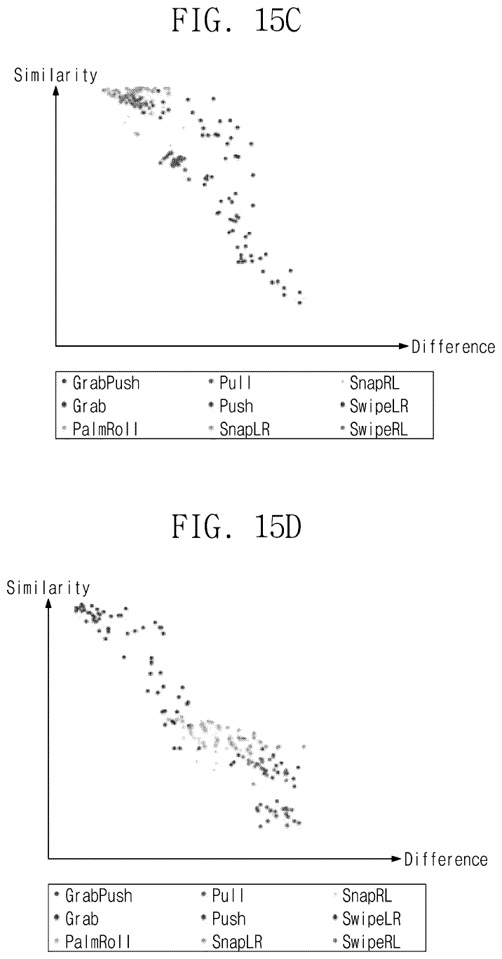

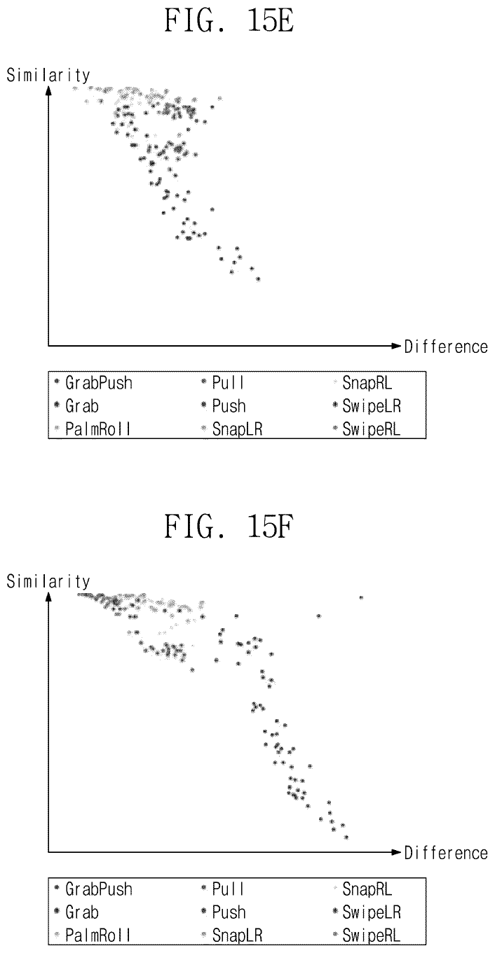

FIGS. 15A to 15F are diagrams from comparing an ideal curve calculated from a trace of a peak curve for a specific gesture with ideal curves of other gestures, according to an embodiment.

FIG. 15A is obtained by comparing the ideal curve calculated from a trace of a peak curve for a push gesture with the ideal curves of other gestures.

FIG. 15B is obtained by comparing the ideal curve calculated from a trace of a peak curve for a pull gesture with the ideal curves of other gestures.

FIG. 15C is obtained by comparing the ideal curve calculated from a trace of a peak curve for a snap gesture with the ideal curves of other gestures.

FIG. 15D is obtained by comparing the ideal curve calculated from a trace of a peak curve for a grab push gesture with the ideal curves of other gestures.

FIG. 15E is obtained by comparing the ideal curve calculated from a trace of a peak curve for a grab gesture with the ideal curves of other gestures.

FIG. 15F is obtained by comparing the ideal curve calculated from a trace of a peak curve for a swipe gesture with the ideal curves of other gestures.

In an embodiment and referring to FIGS. 15A to 15F, a vertical axis denotes the similarity between the ideal curve vector of a specific gesture (or a reference gesture) and the ideal curve vector of each other gesture, and a horizontal axis denotes a distance difference between the ideal curve vector of a specific gesture (or a reference gesture) and the ideal curve vector of each other gesture.

In an embodiment and referring to FIGS. 15A to 15F, the vertical axis indicates that the similarity between the reference gesture and other gestures is great, as the distribution is high, and the horizontal axis indicates that the difference between the reference gesture and other gestures is great, as the distribution is close to the right.

It may be seen that there is a difference in the distribution (vector similarity or distance between vectors) between each of the reference gestures in FIGS. 15A to 15F and other gestures, and thus it may be used to determine gestures.

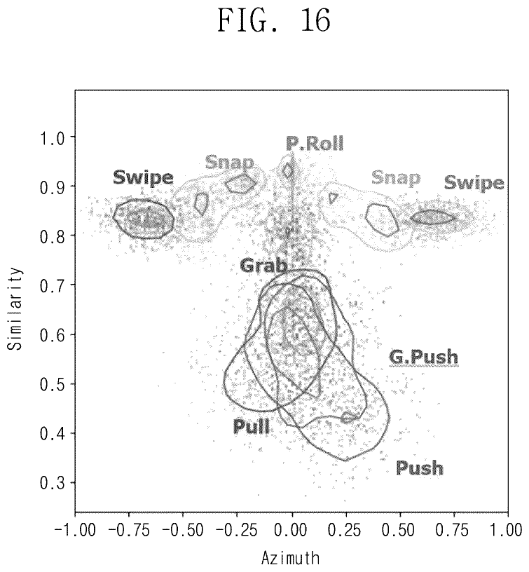

FIG. 16 is a diagram indicated by visualizing a feature distribution according to the similarity between each gesture and an artificial ideal curve, and a time change of angle information, according to an embodiment.

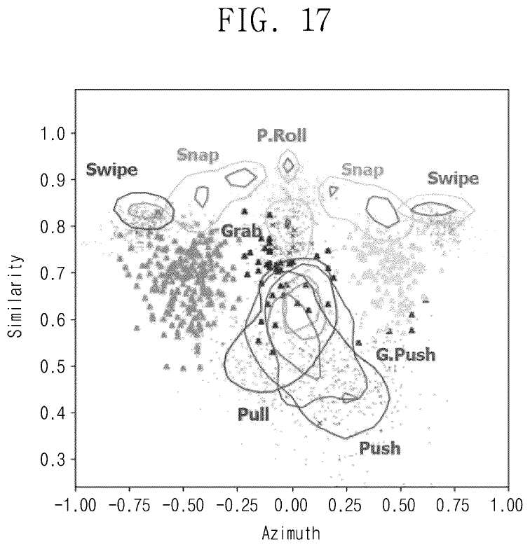

FIG. 17 is a diagram showing the distribution of data used for inference in training results of the AI processor 220, according to an embodiment.

In FIGS. 16 and 17, a vertical axis indicates the similarity between each gesture and an artificial ideal curve, and a horizontal axis indicates a time change (azimuth) of angle information.

In an embodiment, the visualizer 240 shown in FIG. 2 may visualize features of each gesture analyzed by the analyzer 230 as shown in FIG. 16.

In an embodiment, a training scope and inference may be identified by visualizing the features of each gesture. Moreover, when the inference precision does not satisfy expectations, it is expected to improve the inference precision of the AI processor 220 by preparing a data set for correcting data in each range.

The algorithm of the analyzer 230, according to an embodiment, may observe the input (measurement) state of the gesture detected by mm Wave in real time.

In an embodiment and referring to FIGS. 16 and 17, it may be seen that some of the data used in the inference of the AI processor 220 significantly deviates from the training range. In FIG. 17, a triangle indicates error data in inference results of the AI processor 220.

Among the data used in the inference of the AI processor 220, there are many snap gestures and grab gestures that deviate from the training range.

In an embodiment and referring to FIG. 16, as the number of data increases in the feature distribution of gestures, the deviation factors increase, and some of the gesture distributions may overlap each other (e.g., push and grab push). In this case, the separability of the gesture distribution may be additionally secured by calculating gesture-specific features (i.e., information other than peak in each frame) or adding separate elements to the similarity of a vector.

Although an embodiment of the invention has been described for illustrative purposes, those skilled in the art will appreciate that various modifications, and substitutions are possible, without departing from the scope and spirit of the invention. Accordingly, the technical scope of the invention is not limited to the detailed description of this specification.

A gesture sensing device as disclosed herein may determine gesture features and may visualize the distribution of the gesture features. Accordingly, training efficiency and inference precision may be improved.

Although embodiments of the invention have been described, it is understood that the invention should not be limited to these embodiments and that various changes and modifications can be made by one of ordinary skill in the art within the spirit and scope of the invention. Therefore, the scope of the invention should not be limited to any single embodiment described herein or otherwise. Moreover, embodiments or parts of the embodiments may be combined in whole or in part without departing from the scope of the invention.

What is claimed is:

1. A gesture sensing device comprising:
a preprocessor configured to output sensing data and to generate a range-Doppler map, wherein the range-Doppler map includes information about a distance, a relative velocity, and an angle to an object based on a reception data signal;
an analyzer configured to analyze a gesture feature of the object based on the range-Doppler map; and
a visualizer configured to visualize a gesture of the object based on the gesture feature of the object analyzed.

2. The gesture sensing device of claim 1, wherein the analyzer is configured to:
analyze the gesture feature of the object by detecting a temporal change in the gesture of the object using the range-Doppler map.

3. The gesture sensing device of claim 1, wherein the analyzer is configured to:
detect a peak location of the sensing data using the range-Doppler map;
preserve a peak trace of the peak location;
resample a peak of the sensing data to generate a resampled result; and
compare a vector similarity between the peak trace of the peak location with the resampled result.

4. The gesture sensing device of claim 3, wherein the analyzer is configured to:
create an ideal curve of a peak trace of the gesture based on the peak trace of the gesture and the resampled result.

5. The gesture sensing device of claim 4, wherein the visualizer is configured to:
visualize the gesture of the object by using a similarity between the gesture of the object and an artificial ideal curve, and a time change in angle information.

6. The gesture sensing device of claim 4, wherein the analyzer is configured to:
resample the peak trace of the gesture by applying an equation which approximates the peak trace of the gesture to a change in an observed distance, velocity, and signal intensity.

7. The gesture sensing device of claim 1, wherein the preprocessor is configured to:
generate the range-Doppler map by performing Fast Fourier Transform (FFT) on the reception data signal.

8. The gesture sensing device of claim 1, wherein the reception data signal is a signal received through a mmWave antenna.

9. A gesture sensing system comprising:
a transmitter configured to transmit a transmission signal having a mmWave frequency to a transmission antenna;
a mixer configured to output an intermediate frequency signal by combining a reception signal received from a reception antenna with the transmission signal;
a receiver configured to output a reception data signal by performing filtering and analog-to-digital conversion on the intermediate frequency signal;
a preprocessor configured to output sensing data and to generate a range-Doppler map including information about a distance, a relative velocity, and an angle to an object based on the reception data signal;
an analyzer configured to analyze a gesture feature of the object based on the range-Doppler map; and
a visualizer configured to visualize a gesture of the object based on the gesture feature of the object analyzed by the analyzer.

10. The gesture sensing system of claim 9, wherein the analyzer is configured to:
analyze the gesture feature of the object by detecting a temporal change in the gesture of the object using the range-Doppler map.

11. The gesture sensing system of claim 9, wherein the analyzer is configured to:
detect a peak location of the sensing data by using the range-Doppler map;
preserve a peak trace of the peak location;
resample a peak of the sensing data to generate a resampled result; and
compare a vector similarity between the peak trace of the peak location and the resampled result.

12. The gesture sensing system of claim 11, wherein the analyzer is configured to:
create an ideal curve of a peak trace of the gesture based on the peak trace of the gesture and the resampled result.

13. The gesture sensing system of claim 11, wherein the visualizer is configured to:
visualize the gesture of the object by using a similarity between the gesture of the object and an artificial ideal curve, and a time change in angle information.

14. The gesture sensing system of claim 11, wherein the analyzer is configured to:
resample the peak trace of the peak location by applying an equation which approximates the peak trace of the gesture to a change in an observed distance, velocity, and signal intensity.

15. The gesture sensing system of claim 9, wherein the preprocessor is configured to:
generate the range-Doppler map by performing Fast Fourier Transform (FFT) on the reception data signal.

16. A method for sensing a gesture, the method comprising:
generating a range-Doppler map including information about a distance, a relative velocity, and an angle to an object based on a reception data signal;
detecting a peak location of sensing data using the range-Doppler map;
preserving a peak trace of the peak location of sensing data;
resampling a peak of the sensing data to generate a resampled result; and
comparing a vector similarity between the peak trace of the peak location of sensing data and the resampled result.

17. The method of claim 16, further comprising:
creating an ideal curve of a peak trace of the gesture based on the peak trace of the peak location of sensing data and the resampled result.

18. The method of claim 17, further comprising:
visualizing the gesture by using a similarity between the gesture and an artificial ideal curve, and a time change in angle information.

19. The method of claim 16, wherein the resampling of the peak of the sensing data includes:
resampling the peak trace of the peak location of sensing data by applying an equation which approximates the peak trace of the peak location of the sensing data to a change in an observed distance, velocity, and signal intensity.

20. The method of claim 16, wherein the generating of the range-Doppler map includes:
generating the range-Doppler map by performing Fast Fourier Transform (FFT) on the reception data signal.
